(19) United States
(12) Patent Application Publication
(10) Pub. No.: US 2016/0094887 A1
(43) Pub. Date: Mar. 31, 2016

(54) TV PROGRAM-BASED SHOPPING GUIDE SYSTEM AND TV PROGRAM-BASED SHOPPING GUIDE METHOD

(71) Applicant: INSTITUTE FOR INFORMATION INDUSTRY, Taipei City (TW)

(72) Inventors: Wei-Ren Huang, New Taipei City (TW); Yu-Chi Tung, Taipei City (TW); Chih-Lung Tai, New Taipei City (TW)

(21) Appl. No.: 14/597,804

(22) Filed: Jan. 15, 2015

(30) Foreign Application Priority Data
Sep. 25, 2014 (TW) 103133221

(51) Int. Cl. H04N 21/478; G06F 17/27; G06Q 30/06

(52) U.S. Cl. CPC H04N 21/47815; G06Q 30/0631; G06F 17/2765

(57) ABSTRACT

Provided herein are a TV program-based shopping guide system and a TV program-based shopping guide method. The TV program-based shopping guide system includes a detecting module, an expansion module and a recommendation module. The detecting module provides a plurality of key nouns according to program information corresponding to a TV program that a user is watching. The expansion module searches in at least one social network provided with a plurality of web articles according to the key nouns to obtain a plurality of expansion nouns. Each of the expansion nouns corresponds to one of the key nouns. The recommendation module searches in a commodity database according to the key nouns and the expansion nouns to obtain a matched commodity list, and then outputs information related to a plurality of recommended commodities included in the matched commodity list to at least one electronic device.

### BACKGROUND

1. Technical Field

The present invention generally relates to a shopping guide system and a method thereof and, more particularly, to a television (TV) program-based shopping guide system and a TV program-based shopping guide method capable of providing information related to recommended commodities corresponding to a TV program based on information of the TV program that a user is watching.

2. Description of Related Art

Generally, a user may want to acquire information related to commodities shown in a TV program while the user is watching, the user may acquire information related to commodities through many ways. For example, the user use the Internet to search the commodities based on the key nouns and to decide what to buy by referring to articles on a social network.

Users may be influenced by the contents, characters or scenes of the TV program to become interested in certain commodities that appear in the TV program. However, in the conventional art, a mechanism that provides information related to the commodities in the TV program is not yet available. As a result, the user may acquire information related to the commodities corresponding to the TV program through other ways during commercial breaks. However, it is inconvenient for the user to search for information related to the commodities corresponding to the TV program he/she is watching, and this also fails to meet the shopping demand in real time.

To fulfill the shopping demand of the user, the purchase intention of the user to buy the commodities may be increased, if the information related to the commodities corresponding to the TV program can be provided to the user while he/she is watching the TV program, so that he/she does not have to search the commodities on the Internet.

### SUMMARY

One embodiment of the present invention provides a TV program-based shopping guide system. The TV program-based shopping guide system includes a detecting module, an expansion module and a recommendation module. The detecting module provides a plurality of key nouns according to program information corresponding to a TV program that a user is watching. The expansion module searches in at least one social network provided with a plurality of web articles according to the key nouns to obtain a plurality of expansion nouns. Each of the expansion nouns corresponds to one of the key nouns. The recommendation module searches in a commodity database according to the key nouns and the expansion nouns to obtain a matched commodity list, and then outputs information related to a plurality of recommended commodities included in the matched commodity list to at least one electronic device.

One embodiment of the present invention further provides a TV program-based shopping guide method. The TV program-based shopping guide method is for use with the TV program-based shopping guide system. The TV program-based shopping guide system includes a detecting module, an expansion module and a recommendation module. The TV program-based shopping guide method includes steps herein. The detecting module is used to provide a plurality of key nouns according to program information of a TV program that a user is watching. The expansion module is used to search in at least one social network provided with a plurality of web articles according to the plurality of key nouns to obtain a plurality of expansion nouns. Each of the plurality of expansion nouns corresponds to one of the plurality of key nouns. The recommendation module is used to search in a commodity database according to the plurality of key nouns and the plurality of expansion nouns to obtain a matched commodity list, and output information related to a plurality of recommended commodities included in the matched commodity list to at least one electronic device.

As stated above, the TV program-based shopping guide system and the TV program-based shopping guide method according to embodiments of the present invention provide the user with the information related to recommended commodities corresponding to the TV program that he/she is watching. Therefore, it is more likely to meet the user's demand and more likely that the user may buy the commodities.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic block diagram of a TV program-based shopping guide system according to one embodiment of the present invention;

FIG. 2A schematically shows program information according to one embodiment of the present invention;

FIG. 2B schematically shows information related to a commodity database according to one embodiment of the present invention;

FIG. 3 is a schematic block diagram of a TV program-based shopping guide system according to another embodiment of the present invention;

FIG. 4 is a flowchart showing a TV program-based shopping guide method according to one embodiment of the present invention;

FIG. 5 is a flowchart showing a TV program-based shopping guide method according to another embodiment of the present invention;

FIG. 6A is a flowchart showing steps of acquiring rating information of a TV program-based shopping guide method according to one embodiment of the present invention; and

FIG. 6B is a flowchart showing steps of acquiring rating information of a TV program-based shopping guide method according to another embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

The TV program-based shopping guide system and the TV program-based shopping guide method according to embodiments of the present invention provide the user with the information related to recommended commodities corresponding to the TV program that he/she is watching. Therefore, it is more likely to meet the user's demand and that the user may buy the commodities.

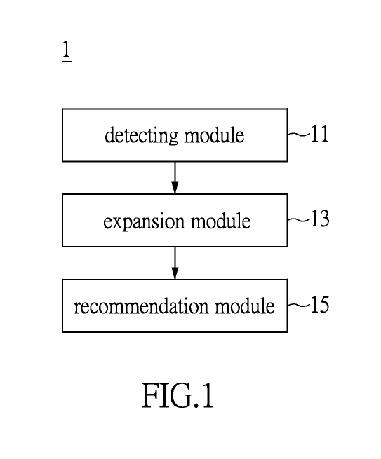

Please refer to FIG. 1, which is a schematic block diagram of a TV program-based shopping guide system 1 according to one embodiment of the present invention. The TV program-based shopping guide system 1 includes a detecting module 11, an expansion module 13 and a recommendation module 15. The detecting module 11 is connected to the expansion module 13. The expansion module 13 is connected to the recommendation module 15. The above mentioned modules may be implemented by pure hardware circuitry or hardware circuitry in combination with hardware or software. To sum up, the present invention is not limited to the implementation of the TV program-based shopping guide system 1. Moreover, the above mentioned modules can be provided integratedly or installed discretely, to which the present invention is not limited. It is noted that the above mentioned modules can communicate with each other through wired or wireless communication, to which the present invention is not limited.

The detecting module 11 provides a plurality of key nouns according to program information of a TV program that a user is watching. The expansion module 13 searches in at least one social network provided with a plurality of web articles according to the key nouns to obtain a plurality of expansion nouns. Each of the expansion nouns corresponds to one of the key nouns. The recommendation module 15 searches in a commodity database (not shown) according to the key nouns and the expansion nouns to obtain a matched commodity list, and then outputs information related to a plurality of recommended commodities included in the matched commodity list to at least one electronic device (not shown).

More particularly, the TV program-based shopping guide system 1 may acquire program information through a database (not shown) provided by the program provider before the TV program begins. Moreover, the detecting module 11 detects the TV program the user is watching. Otherwise, the user can input information to inform the detecting module 11 of the TV program the user is watching so as to provide a plurality of key nouns according to the program information of the TV program. To sum up, the present invention is not limited to the way the program information is acquired and the way the detecting module 11 is informed of the TV program the user is watching. Modifications may be made according to practical needs or use by those with ordinary skills in the art.

It is a main feature of the detecting module 11 to provide a plurality of key nouns based on the program information of the TV program the user is watching. The key nouns can be used to search on the social network. Since the accuracy of a commodity search with the use of the key nouns only may be insufficient, the expansion module 13 is needed to search a plurality of related articles corresponding to the key nouns from the web articles on the social network according to the key nouns and to obtain a plurality of expansion nouns by analyzing the related articles so that the commodities can be searched according to the expansion nouns and the key nouns.

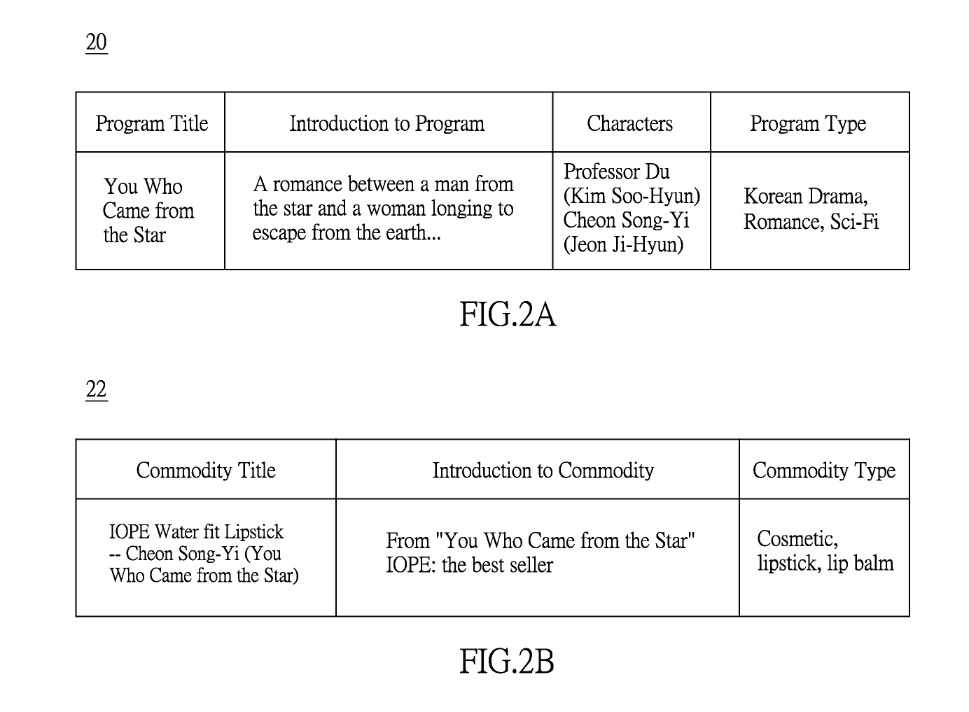

Afterwards, please refer to FIG. 2A, which schematically shows program information according to one embodiment of the present invention. In FIG. 2A, the program information 20 provides contents of the program title, introduction to the program, characters and the program type. To sum up, the present invention is not limited to the contents of the program information. Please also refer to FIG. 2B, which schematically shows information related to the commodity database according to one embodiment of the present invention. In FIG. 2B, the commodity information 22 in the commodity database may include contents of the commodity title, introduction to the commodity and the commodity type.

Referring to FIG. 1, FIG. 2A and FIG. 2B, for example, the key nouns acquired by the detecting module 11 may include “You Who Came From the Star”, “Cheon Song-Yi”, “Du Min-Joon”, etc. The expansion nouns acquired by the expansion module 13 may include “lip balm”, “lipstick”, “fried chicken”, “Korean Drama”, etc. More particularly, “lip balm” and “lipstick” correspond to “Cheon Song-Yi”, “fried chicken” corresponds to “Du Min-Joon”, and “Korean Drama” corresponds to “You Who Came from the Star”. A matched commodity list searched from the commodity database by the recommendation module 15 according to the key nouns and the expansion nouns may include “lip balm” as shown in FIG. 2B. The related information 22 of the lip balm will be delivered to an electronic device held by the user. Therefore, the information 22 related to the lip balm will be displayed on the electronic device when the user is watching “You Who Came from the Star”.

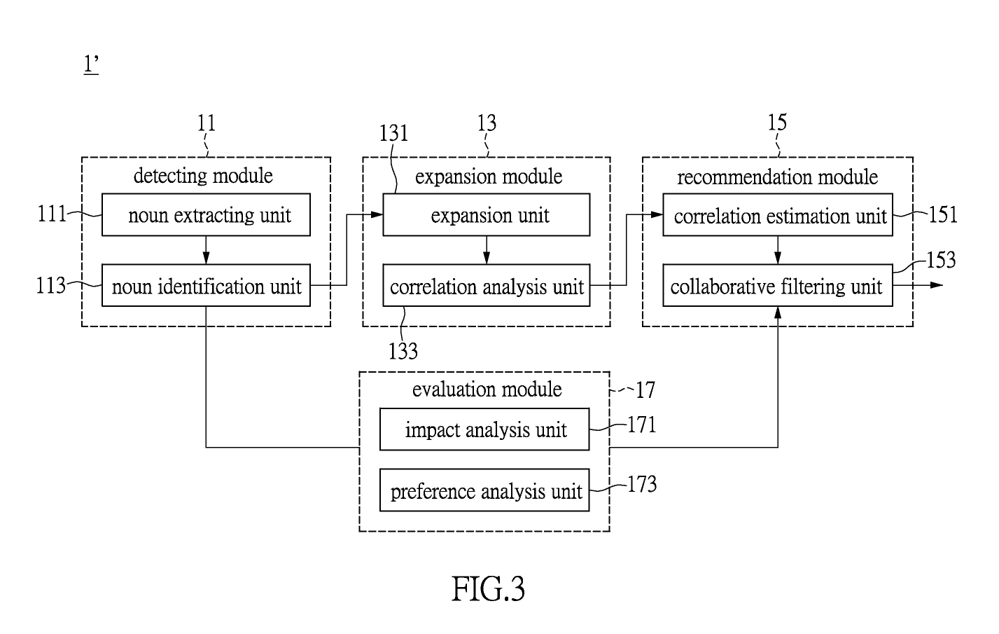

On the other hand, the user may want the recommended commodities corresponding to the TV program to be ranked according to the rating information provided in the web articles on the social network so that he/she can choose one with higher rating from the recommended commodities. Therefore, please refer to FIG. 3, which is a schematic block diagram of a TV program-based shopping guide system 1′ according to another embodiment of the present invention. Compared to the TV program-based shopping guide system 1 in FIG. 1, the TV program-based shopping guide system 1′ further includes an evaluation module 17. The evaluation module 17 is connected to the detecting module 11 and the recommendation module 15. Moreover, the evaluation module 17 may be implemented by pure hardware circuitry or hardware circuitry in combination with hardware or software.

The evaluation module 17 searches in the commodity database to obtain a plurality of searched commodities according to the plurality of key nouns and analyzes an impact and/or a preference of the plurality of web articles corresponding to the plurality of searched commodities to provide rating information of the plurality of searched commodities. The recommendation module 15 further adjusts the priority of the plurality of recommended commodities in the matched commodity list and/or deletes at least one of the plurality of recommended commodities in the matched commodity list according to the rating information. Moreover, some elements in FIG. 3 are similar to those in FIG. 1 and are labeled with the same numbers. Descriptions thereof are not to be presented.

The implementation of the modules of the TV program-based shopping guide system 1′ will be described. However, it is noted that the description is only exemplifying the modules of the TV program-based shopping guide system 1′ and the present invention is not limited thereto. In addition, with the detailed descriptions of the modules of the TV program-based shopping guide system 1′, those with ordinary skills in the art may understand the implementation of the modules of the TV program-based shopping guide system 1 as shown in FIG. 1.

More particularly, the detecting module 11 includes a noun extracting unit 111 and a noun identification unit 113. The noun extracting unit 111 conducts a word segmentation process on the program information to obtain a plurality of word segments and conducts a lexical analysis on the plurality of word segments to obtain a plurality of nouns. The noun identification unit 113 combines a set of consecutively appearing nouns in the program information into a compound noun. The plurality of key nouns comprise the plurality of nouns and the plurality of compound nouns.

For example, referring to FIG. 2A and FIG. 3, the TV program-based shopping guide system 1′ acquires the program information 20 of the TV program the user is watching. For example, the noun extracting unit 111 conducts a word segmentation process on the sentence or the contents in the program information 20, for example, “You Who Came From the Star”, “A romance between a man from the star and a woman longing to escape from the earth . . . ”, “Professor Du, Kim Soo-Hyun” and “Cheon Song-Yi, Jeon Ji-Hyun”, “Korean Drama, romance, and Sci-Fi” to obtain a plurality of word segments, for example, “you”, “who”, “came”, “from”, “star”, “Du”, “Professor” and “Cheon Song-Yi”, etc. The noun extracting unit 111 conducts a lexical analysis on the plurality of word segments to obtain a plurality of nouns, for example, “star”, “Professor”, etc. In other words, the noun extracting unit 111 reserves the word segments that are nouns from the sentence or the contents in the program information 20.

Next, the noun identification unit 113 combines a set of consecutively appearing nouns in the program information 20 into a compound noun, for example “You Who Came from the Star”, “Professor Du”, “Cheon Song-Yi”, etc. In other words, the noun identification unit 113 discovers a set of consecutively appearing nouns from the program information 20 and combines the consecutively appearing nouns into a compound noun. Therefore, the plurality of key nouns provided by the detecting module 11 include the plurality of nouns reserved by the noun extracting unit 111 (for example, “star”, “Professor”, etc) and the plurality of compound nouns discovered by the noun identification unit 113 (for example, “You Who Came from the Star”, “Professor Du”, “Cheon Song-Yi”, etc).

Moreover, the main feature of the expansion module 13 is to conduct a search on the social network based on the plurality of key nouns provided by the detecting module 11 to obtain a plurality of expansion nouns related to the plurality of key nouns. Accordingly, the expansion module 13 includes an expansion unit 131 and a correlation analysis unit 133. The expansion unit 131 searches among the plurality of web articles on the social network according to the plurality of key nouns to obtain a plurality of related articles among the web articles related to the plurality of key nouns and analyzes all the nouns in the related articles to obtain a plurality of nominated nouns. The correlation analysis unit 133 calculates a count where each of the plurality of nominated nouns and one of the plurality of key nouns corresponding thereto appear in pairs in the plurality of related articles and selects part of the plurality of nominated nouns as the plurality of expansion nouns according to the count.

Moreover, the recommendation module 15 conducts a search in a commodity database according to the plurality of key nouns and the plurality of expansion nouns to obtain a matched commodity list. In other words, with the use of information in the commodity database, a commodity can be discovered according to the expansion nouns and the key noun. The information of the commodity may be stored in the matched commodity list. Next, the recommendation module 15 outputs information related to a plurality of recommended commodities included in the matched commodity list to at least one electronic device. In other words, the user can access through an electronic device to the information related to the recommended commodities in the TV program when the user is watching a TV program so as to provide the user with a more convenient shopping environment.

For example, the recommendation module 15 may conduct a search in the commodity database according to the expansion noun “lipstick” and the related key noun “Cheon Song-Yi” to discover information related to a commodity “A-branded lipstick a” in the commodity database. The information matches the expansion noun “lipstick” and the related key noun “Cheon Song-Yi”. Therefore, the recommendation module 15 stores “A-branded lipstick a” in the matched commodity list. Next, the recommendation module 15 outputs information related to recommended commodities in the matched commodity list to the electronic device (for example, a smart phone). Therefore, the information related to the commodity “A-branded lipstick a” related to “You Who Came from the Star” in the matched commodity list can be retrieved on the electronic device when the user is watching the TV program “You Who Came from the Star”.

On the other hand, the matched commodity list acquired by the recommendation module 15 may have plenty of recommended commodities. To effectively rank the recommended commodities in the matched commodity list, the recommendation module 15 adjusts the priority of the recommended commodities in the matched commodity list according to the count corresponding to the expansion nouns and/or the advertisement expense.

The recommended commodities that appear more frequently or have stronger correlation are ranked higher in the matched commodity list. The flagship recommended commodities may also be ranked higher in the matched commodity list. To sum up, the present invention is not limited to the implementation of the matched commodity list and those with ordinary skills may modify the matched commodity list according to practical demand or applications.

Moreover, as stated above, from a viewpoint of shopping demand of a consumer, it is likely that he/she may refer to discussions on the social network before he/she decides whether to buy a certain commodity or not. Accordingly, compared to the TV program-based shopping guide system 1 in FIG. 1, the TV program-based shopping guide system 1′ further includes an evaluation module 17 so as to meet the consumer's demand and avoid redundant procedures to evaluate a certain commodity on the Internet.

For example, the evaluation module 17 conducts a search in the commodity database corresponding to the key noun “Cheon Song-Yi” to obtain a plurality of searched commodities, for example, “A-branded lipstick a”, “A-branded lip balm b”, “B-branded lipstick c”, “C-branded lip balm d”, etc. Accordingly, each of the searched commodities corresponds to one of the key nouns.

Next, the evaluation module 17 analyzes an impact and/or a preference of the plurality of web articles corresponding to the plurality of searched commodities to provide rating information of the plurality of searched commodities. For example, “A-branded lipstick a” is rated +5, “A-branded lip balm b” is rated +10, “B-branded lipstick c” is rated +0, “C-branded lip balm d” is rated −7, and so on.

As stated above, to effectively rank the recommended commodities in the matched commodity list, the recommendation module 15 adjusts the priority of the recommended commodities in the matched commodity list according to the rating information. For example, the recommended commodities with higher rating are ranked higher in the matched commodity list, and the recommended commodities with lower rating are deleted from the matched commodity list so as to meet the consumer's preference for high-quality commodities.

The recommendation module 15 may include a correlation estimation unit 151 and a collaborative filtering unit 153. The correlation estimation unit 151 provides the matched commodity list by searching in the commodity database based on the plurality of key nouns and the plurality of expansion nouns, and adjusts the priority of the plurality of recommended commodities in the matched commodity list according to the count corresponding to the plurality of expansion nouns. The collaborative filtering unit 153 adjusts the priority of the plurality of recommended commodities in the plurality of the matched commodity list and/or deletes at least one of the plurality of recommended commodities in the matched commodity list according to the rating information. Moreover, in FIG. 1, since the TV program-based shopping guide system 1 does not have an evaluation module, the recommendation module 15 may have no collaborative filtering unit 153.

The evaluation module 17 includes an impact analysis unit 171. The impact analysis unit 171 searches a plurality of commodity articles related to the plurality of searched commodities from the plurality of web articles on the social network according to the plurality of searched commodities, calculates a feedback count of each of the plurality of commodity articles, and provides the rating information of the plurality of searched commodities according to the feedback count of each of the plurality of commodity articles.

The impact analysis unit 171 determines the rating information of the searched commodities in the commodity articles according to the feedback count of commodity articles. For example, there are 88 responses to the commodity articles related to “A-branded lipstick a”, and 62 responses to the commodity articles related to “B-branded lipstick c”. In other words, there are more consumers discussing “A-branded lipstick a” on the social network. Therefore, the impact analysis unit 171 gives heavier weight on the rating information of “A-branded lipstick a” than the “B-branded lipstick c”.

Moreover, the evaluation module 17 further includes a preference analysis unit 173. The preference analysis unit 173 searches a plurality of commodity articles related to the plurality of searched commodities from the social network according to the plurality of searched commodities. The preference analysis unit 173 calculates a positive term count and a negative term count of each of the plurality of commodity articles to obtain an evaluated result of each of the plurality of commodity articles, and provides the rating information of the plurality of searched commodities according to the evaluated result. The impact analysis unit 171 calculates the feedback count corresponding to commodity articles, while the preference analysis unit 173 calculates a positive term count and a negative term count corresponding to commodity articles.

For example, one of the commodity articles is written by a user who used “A-branded lipstick a”. If he/she thinks “A-branded lipstick a” is excellent, there must be many positive terms in the commodity articles (for example, “excellent”, “superb”, “practical” and “like”, etc). The preference analysis unit 173 will provide the “A-branded lipstick a” with a higher rating information. On the contrary, if he/she thinks “B-branded lipstick c” is not excellent, there must be many negative terms in the commodity articles (for example, “poor”, “fair”, “impractical” and “dislike”, etc). The preference analysis unit 173 provides the rating information on “B-branded lipstick c” being lower.

It is noted that the impact analysis unit 171 and the preference analysis unit 173 can be installed at the same time but only one of them may be selected. When both the impact analysis unit 171 and the preference analysis unit 173 are provided at the same time, the evaluation module 17 provides rating information by giving different weights upon the impact and preference corresponding to web articles in the searched commodities. To sum up, the present invention is not limited to the way the evaluation module 17 provides rating information.

With the use of the evaluation module 17 and the recommendation module 15, the TV program-based shopping guide system 1 is able to provide rating information for the user with recommended commodities. Such rating information may help the use the user to decide whether he/she will buy the recommended commodities.

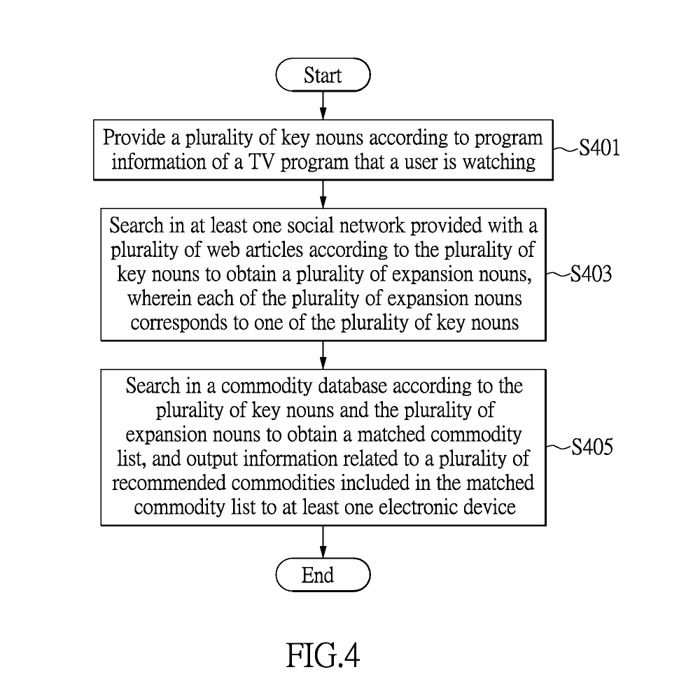

To further describe the flowchart of the TV program-based shopping guide system, the present invention further provides one embodiment of a TV program-based shopping guide method. Please refer to FIG. 4, which is a flowchart showing a TV program-based shopping guide method according to one embodiment of the present invention. The method of the present invention can be used in both the TV program-based shopping guide system 1 and the TV program-based shopping guide system 1′ in FIG. 1 and FIG. 3. Detailed descriptions on the steps have been previously provided and will not be repeated herein.

First, in step S401, a plurality of key nouns are provided according to program information of a TV program that a user is watching. In step S403, a search is conducted in at least one social network provided with a plurality of web articles according to the plurality of key nouns to obtain a plurality of expansion nouns, wherein each of the plurality of expansion nouns corresponds to one of the plurality of key nouns. In step S405, a search is conducted in a commodity database according to the plurality of key nouns and the plurality of expansion nouns to obtain a matched commodity list, and information related to a plurality of recommended commodities included in the matched commodity list is outputted to at least one electronic device.

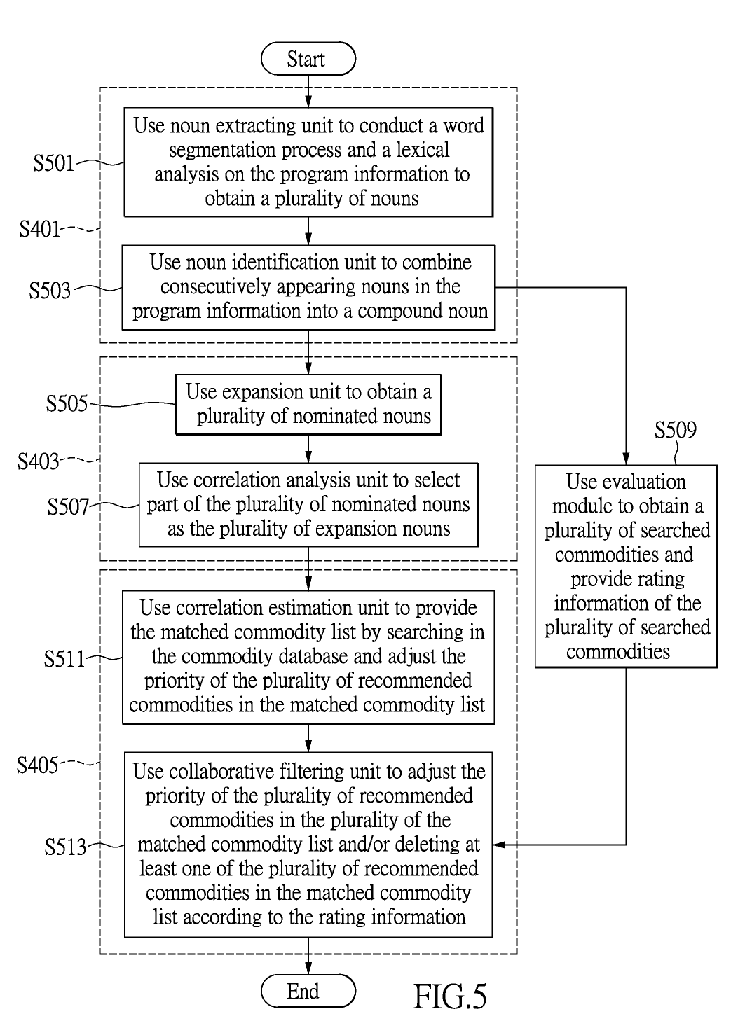

On the other hand, please refer to FIG. 5, which is a flowchart showing a TV program-based shopping guide method according to another embodiment of the present invention. In FIG. 5, part of the steps are similar to those in FIG. 4 with similar numbers, and descriptions thereof are repeated herein. Compared to the TV program-based shopping guide method in FIG. 4, the TV program-based shopping guide method in FIG. 5 further takes rating information into account. However, there is provided one example of the TV program-based shopping guide method, but the present is not limited thereto.

The TV program-based shopping guide method in FIG. 5 can be used with the TV program-based shopping guide system in FIG. 3. Therefore, please refer to FIG. 3 and FIG. 5 for better understanding. Moreover, detailed descriptions on the steps have been previously provided and will not be repeated herein.

First, in step S501, the noun extracting unit 111 is used to conduct a word segmentation process and a lexical analysis is used on the program information to obtain a plurality of nouns. In step S503, the noun identification unit 113 is used to combine consecutively appearing nouns in the program information into a compound noun.

Then, in step S505, the expansion unit 131 is used to obtain a plurality of nominated nouns. In step S507, the correlation analysis unit 133 is used to select part of the plurality of nominated nouns as the plurality of expansion nouns.

In step S509, the evaluation module 17 is used to obtain a plurality of searched commodities and provide rating information of the plurality of searched commodities.

In step S511, the correlation estimation unit 151 is used to provide the matched commodity list by searching in the commodity database and adjusting the priority of the plurality of recommended commodities in the matched commodity list. Moreover, in S513, the collaborative filtering unit 153 is used to adjust the priority of the plurality of recommended commodities in the plurality of the matched commodity list and/or delete at least one of the plurality of recommended commodities in the matched commodity list according to the rating information.

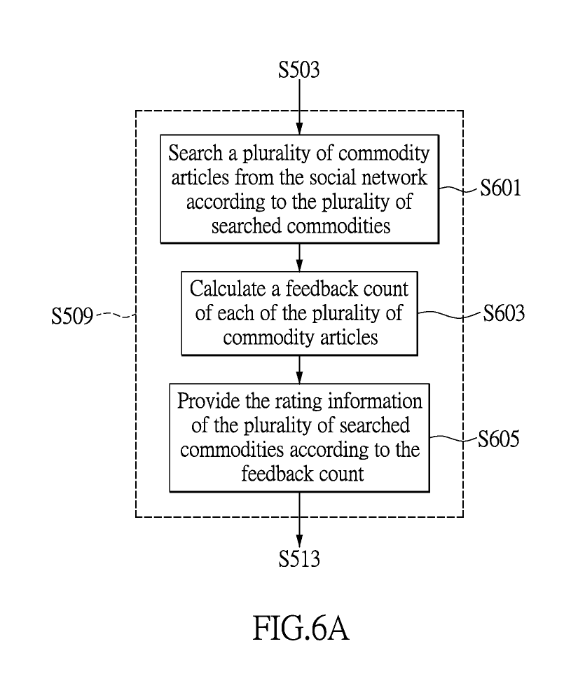

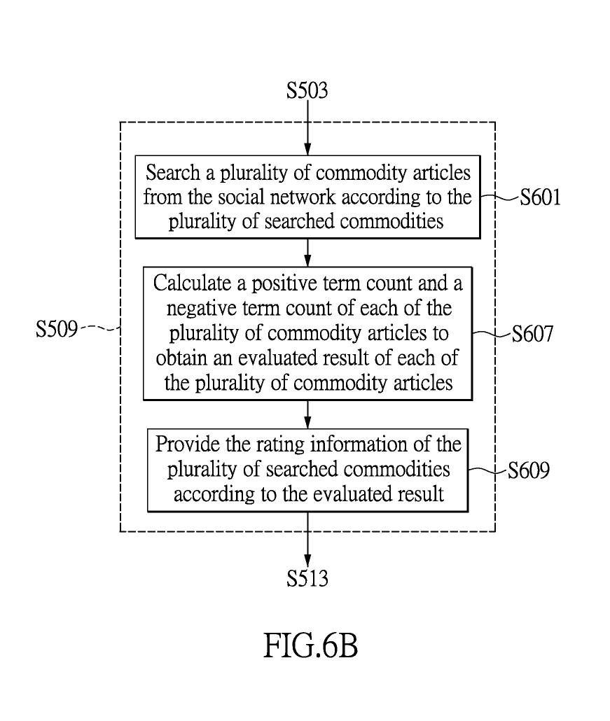

To further describe step S509 for providing rating information, steps in step S509 will be provided exemplifying but not limiting the present invention. Please refer to FIG. 6A and FIG. 6B, wherein FIG. 6A is a flowchart showing steps of acquiring rating information of a TV program-based shopping guide method according to one embodiment of the present invention; and FIG. 6B is a flowchart showing steps of acquiring rating information of a TV program-based shopping guide method according to another embodiment of the present invention. Part of the steps in FIG. 6A and FIG. 6B are similar to the steps in FIG. 5 with the same reference. Therefore, descriptions thereof are not presented. It is noted that both or only one of the methods for acquiring rating information as shown in FIG. 6A and FIG. 6B can be used in the TV program-based shopping guide method.

Referring to FIG. 5 and FIG. 6A, step S509 includes step S601 to step S605. First, in step S601, a plurality of commodity articles are searched from the social network according to the plurality of searched commodities. In step S603, a feedback count of each of the plurality of commodity articles is calculated. In step S605, the rating information of the plurality of searched commodities is provided according to the feedback count.

Furthermore, referring to FIG. 5 and FIG. 6B, step S509 includes step S601 and step S607 to step S609. First, in step S601, a plurality of commodity articles are searched from the social network according to the plurality of searched commodities. In step S607, a positive term count and a negative term count of each of the plurality of commodity articles are calculated to obtain an evaluated result of each of the plurality of commodity articles. In step S609, the rating information of the plurality of searched commodities is provided according to the evaluated result.

From the above, the TV program-based shopping guide system and the TV program-based shopping guide method according to embodiments of the present disclosure provide the user with information related to recommended commodities corresponding to the TV program that he/she is watching. Therefore, the user's shopping demand may be fulfilled, and the purchase intention of the commodities of the user may be increased.

The above-mentioned descriptions represent merely the exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. A television (TV) program-based shopping guide system, comprising:
a detecting module providing a plurality of key nouns according to program information of a TV program that a user is watching;
an expansion module searching in at least one social network provided with a plurality of web articles according to said plurality of key nouns to generate a plurality of expansion nouns, wherein each of said plurality of expansion nouns corresponds to one of said plurality of key nouns; and
a recommendation module searching in a commodity database according to said plurality of key nouns and said plurality of expansion nouns to generate a matched commodity list, and outputting information related to a plurality of recommended commodities included in said matched commodity list to at least one electronic device.

2. The TV program-based shopping guide system of claim 1, wherein said expansion module comprises:
an expansion unit searching said plurality of web articles on said social network according to said plurality of key nouns to obtain a plurality of related articles of said web articles related to said plurality of key nouns and analyzing nouns in said related articles to obtain a plurality of nominated nouns, wherein each of said plurality of nominated nouns corresponds to one of said plurality of key nouns; and
a correlation analysis unit calculating a count that each of said plurality of nominated nouns and one of said plurality of key nouns corresponding thereto both appear in one of said plurality of related articles and selecting part of said plurality of nominated nouns as said plurality of expansion nouns according to said count.

3. The TV program-based shopping guide system of claim 2, wherein each of said plurality of nominated nouns is selected as one of said plurality of expansion nouns according to an threshold.

4. The TV program-based shopping guide system of claim 1, wherein said detecting module comprises:
a noun extracting unit conducting a word segmentation process on said program information to obtain a plurality of word segments and conducting a lexical analysis on said plurality of word segments to obtain a plurality of nouns; and
a noun identification unit combining a set of consecutively appearing nouns in said program information into a compound noun, wherein said plurality of key nouns comprise said plurality of nouns and said plurality of compound nouns.

5. The TV program-based shopping guide system of claim 2, wherein said recommendation module adjusts a priority of said plurality of recommended commodities in said matched commodity list according to said count corresponding to said plurality of expansion nouns and/or an advertisement expense.

6. The TV program-based shopping guide system of claim 5, further comprising:
an evaluation module searching in said commodity database to obtain a plurality of searched commodities according to said plurality of key nouns and analyzing an impact and/or a preference of said plurality of web articles corresponding to said plurality of searched commodities to provide rating information of said plurality of searched commodities, wherein each of said plurality of searched commodities corresponds to one of said plurality of key nouns;
wherein said recommendation module further adjusts said priority of said plurality of recommended commodities in said matched commodity list and/or deletes at least one of said plurality of recommended commodities in said matched commodity list according to said rating information.

7. The TV program-based shopping guide system of claim 6, wherein said recommendation module comprises:
a correlation estimation unit providing said matched commodity list by searching in said commodity database based on said plurality of key nouns and said plurality of expansion nouns, and adjusting said priority of said plurality of recommended commodities in said matched commodity list according to said count corresponding to said plurality of expansion nouns; and
a collaborative filtering unit adjusting said priority of said plurality of recommended commodities in said plurality of said matched commodity list and/or deleting at least one of said plurality of recommended commodities in said matched commodity list according to said rating information.

8. The TV program-based shopping guide system of claim 6, wherein said evaluation module comprises:
an impact analysis unit searching a plurality of commodity articles related to said plurality of searched commodities from said plurality of web articles on said social network according to said plurality of searched commodities, calculating a feedback count of each of said plurality of commodity articles, and providing said rating information of said plurality of searched commodities according to said feedback count of each of said plurality of commodity articles.

9. The TV program-based shopping guide system of claim 6, wherein said evaluation module comprises:
a preference analysis unit searching a plurality of commodity articles related to said plurality of searched commodities from said social network according to said plurality of searched commodities, calculating a positive term count and a negative term count of each of said plurality of commodity articles to obtain an evaluated result of each of said plurality of commodity articles, and providing said rating information of said plurality of searched commodities according to said evaluated result.

10. A television (TV) program-based shopping guide method for use with a TV program-based shopping guide system, said TV program-based shopping guide system comprising a detecting module, an expansion module and a recommendation module, and said TV program-based shopping guide method comprising steps of:
using said detecting module to provide a plurality of key nouns according to program information of a TV program that a user is watching;
using said expansion module to search in at least one social network provided with a plurality of web articles according to said plurality of key nouns to obtain a plurality of expansion nouns, wherein each of said plurality of expansion nouns corresponds to one of said plurality of key nouns; and
using said recommendation module to search in a commodity database according to said plurality of key nouns and said plurality of expansion nouns to obtain a matched commodity list, and outputting information related to a plurality of recommended commodities included in said matched commodity list to at least one electronic device.

11. The TV program-based shopping guide method of claim 10, wherein said expansion module comprises an expansion unit and a correlation analysis unit, and said TV program-based shopping guide method comprises steps of:
using said expansion unit to search among said plurality of web articles on said social network according to said plurality of key nouns to obtain a plurality of related articles among said web articles related to said plurality of key nouns and analyzing nouns in said related articles to obtain a plurality of nominated nouns, wherein each of said plurality of nominated nouns corresponds to one of said plurality of key nouns; and
using said correlation analysis unit to calculate a count that each of said plurality of nominated nouns and said one of said plurality of key nouns corresponding thereto appear in pairs in said plurality of related articles and selecting part of said plurality of nominated nouns as said plurality of expansion nouns according to said count.

12. The TV program-based shopping guide method of claim 11, wherein each of said plurality of nominated nouns is selected as one of said plurality of expansion nouns when said count is larger than an threshold, or said part of said plurality of nominated nouns with said count being higher are selected as said plurality of expansion nouns.

13. The TV program-based shopping guide method of claim 10, wherein said detecting module comprises a noun extracting unit and a noun identification unit, and said TV program-based shopping guide method comprises steps of:
using said noun extracting unit to conduct a word segmentation process on said program information to obtain a plurality of word segments and conducting a lexical analysis on said plurality of word segments to obtain a plurality of nouns; and
using said noun identification unit to combine a set of consecutively appearing nouns in said program information into a compound noun, wherein said plurality of key nouns comprise said plurality of nouns and said plurality of compound nouns.

14. The TV program-based shopping guide method of claim 11, wherein said recommendation module adjusts a priority of said plurality of recommended commodities in said matched commodity list according to said count corresponding to said plurality of expansion nouns and/or an advertisement expense.

15. The TV program-based shopping guide method of claim 14, wherein said TV program-based shopping guide system further comprising an evaluation module, and said TV program-based shopping guide method further comprises steps of:
using said evaluation module to search in said commodity database to obtain a plurality of searched commodities according to said plurality of key nouns and analyzing an impact and/or a preference of said plurality of web articles corresponding to said plurality of searched commodities to provide rating information of said plurality of searched commodities, wherein each of said plurality of searched commodities corresponds to one of said plurality of key nouns;
wherein said recommendation module further adjusts said priority of said plurality of recommended commodities in said matched commodity list and/or deletes at least one of said plurality of recommended commodities in said matched commodity list according to said rating information.

16. The TV program-based shopping guide method of claim 15, wherein said recommendation module comprises a correlation estimation unit and a collaborative filtering unit, and said TV program-based shopping guide method further comprises steps of:
using said correlation estimation unit to provide said matched commodity list by searching in said commodity database based on said plurality of key nouns and said plurality of expansion nouns, and adjusting said priority of said plurality of recommended commodities in said matched commodity list according to said count corresponding to said plurality of expansion nouns; and
using said collaborative filtering unit to adjust said priority of said plurality of recommended commodities in said plurality of said matched commodity list and/or deleting at least one of said plurality of recommended commodities in said matched commodity list according to said rating information.

17. The TV program-based shopping guide method of claim 16, wherein said evaluation module comprises an impact analysis unit, and said TV program-based shopping guide method comprises steps of:
using said impact analysis unit to search a plurality of commodity articles related to said plurality of searched commodities from said plurality of web articles on said social network according to said plurality of searched commodities, calculating a feedback count of each of said plurality of commodity articles, and providing said rating information of said plurality of searched commodities according to said feedback count of each of said plurality of commodity articles.

18. The TV program-based shopping guide method of claim 16, wherein said evaluation module comprises a preference analysis unit, and said TV program-based shopping guide method comprises steps of:
using said preference analysis unit to search a plurality of commodity articles related to said plurality of searched commodities from said social network according to said plurality of searched commodities, calculating a positive term count and a negative term count of each of said plurality of commodity articles to obtain an evaluated result of each of said plurality of commodity articles, and providing said rating information of said plurality of searched commodities according to said evaluated result.
